(19) United States
(12) Patent Application Publication
(10) Pub. No.: US 2016/0262128 A1
(43) Pub. Date: Sep. 8, 2016

(54) NOTIFYING A USER OF CRITICAL EMAILS VIA TEXT MESSAGES

(71) Applicant: HEWLETT PACKARD ENTERPRISE DEVELOPMENT LP, Houston, TX (US)

(72) Inventors: Joshua Hailpern, Sunnyvale, CA (US); Kyle Kasie Rector, Palo Alto, CA (US)

(21) Appl. No.: 15/024,941

(22) PCT Filed: Sep. 27, 2013
(86) PCT No.: PCT/US2013/062348

§ 371 Date: Mar. 25, 2016

(51) Int. Cl. H04W 68/00; H04L 12/24; H04L 29/08; H04W 4/14

(52) U.S. Cl. CPC H04W 68/005; H04W 4/14; H04L 41/026; H04L 67/22

(57) ABSTRACT

Critical emails for a user are identified using a set of predictive models of email importance. The email usage of the user is monitored to refine the identification of the critical emails. The user is notified of the critical email via text message alerts.

### BACKGROUND

Electronic mail (or email for short) has become a primary method of communication for people within and beyond enterprises. It is estimated that over 100 billion emails are exchanged worldwide per day and that over 20% of an employee's work week is spent on email. Despite the proliferation of social networking communities and other communication tools, email continues to dominate enterprise communications. While email communication is empowering and has changed workplace habits, the large amounts of email sent to employees per day has led to a poverty of attention. As emails became more abundant, the users' ability to process them becomes increasingly constrained.

Email overload is a well-established problem, with many emails vying for a user's attention based on information, personal utility and task importance. The content of the emails can further exacerbate email overload when a sender requests for information, enforces a limed deadline, or applies pressure to reply with a sense of immediacy. Adding to the volume of emails received, the majority of incoming emails may not be relevant or need immediate attention. While there are strategies employed to triage emails, some emails fall through the cracks (e.g., high priority emails that arrive when users are away, or forgotten emails that never get addressed). Users may be left hopeless that they will someday keep their emails under control.

### BRIEF DESCRIPTION OF THE DRAWINGS

The present application may be more fully appreciated in connection with the following detailed description taken in conjunction with the accompanying drawings, in which like reference characters refer to like parts throughout, and in which;

FIG. 1 illustrates a schematic diagram of an environment where an email management system is used in accordance with various examples to notify a user of critical emails via text message alerts;

FIG. 2 illustrates examples of physical and logical components for implementing the email management system;

FIGS. 3A-L show example email attributes extracted by the email management system to classify emails as critical or non-critical;

FIG. 4 illustrates example experience sampling prompts to generate an experience sampling training set;

FIG. 5 is a flowchart for notifying users of critical emails via text message alerts;

FIG. 6 is a flowchart for classifying a new email as critical or non-critical;

FIG. 7 is a flowchart for refining the classification of emails based on users'interactions with the emails; and

FIG. 8 is a schematic diagram illustrating text message alert options for the email management system.

### DETAILED DESCRIPTION

An email management system for notifying users of critical emails via text messages is disclosed. The email management system identifies critical emails for a user, monitors email usage of the user to refine the identification of critical emails, and notifies the user of the identified critical emails via text message alerts. A critical email, as generally described herein, is a message, appointment or meeting notification that is too important to miss or forget. For example, an email expressing urgency in a reply, an email coming from one's manager with an immediate request or an email conveying an emergency in a community may all be critical emails. As described in more detail below, users receive text message alerts via a Short Message Service (“SMS”) on a mobile device (e.g., phone, smartphone or other SMS-enabled appliance) to notify them of critical emails that may otherwise be forgotten or ignored in their email mailbox.

In various examples, the email management system is implemented in a client/server architecture with the server having an email classification module and an email notification module, and the client having an email monitoring module coupled to a user's email system (e.g., Microsoft® Outlook, Pine, IBM Notes, etc.). The email classification module classifies or identifies a user's emails as critical or non-critical based on predictive models of email importance. The models take into account extracted email attributes and are derived based on an experience sampling training set. Emails that are identified as critical are assigned a completion time and completion condition that is used to generate a text message alert. The completion time specifies when (e.g., a time period relative to that individual's calendar, broader schedule, or information within the email) an action/activity (e.g., a reply, an acceptance to a meeting notification, etc.) on the email is due. The email monitoring module monitors email usage of the user to capture the user's interactions with the emails and refine the identification of the critical emails over time. The email notification module notifies the user of the critical emails based on the monitored usage and via text message alerts. Users are notified of critical emails when the emails are due, rather than when they are received.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

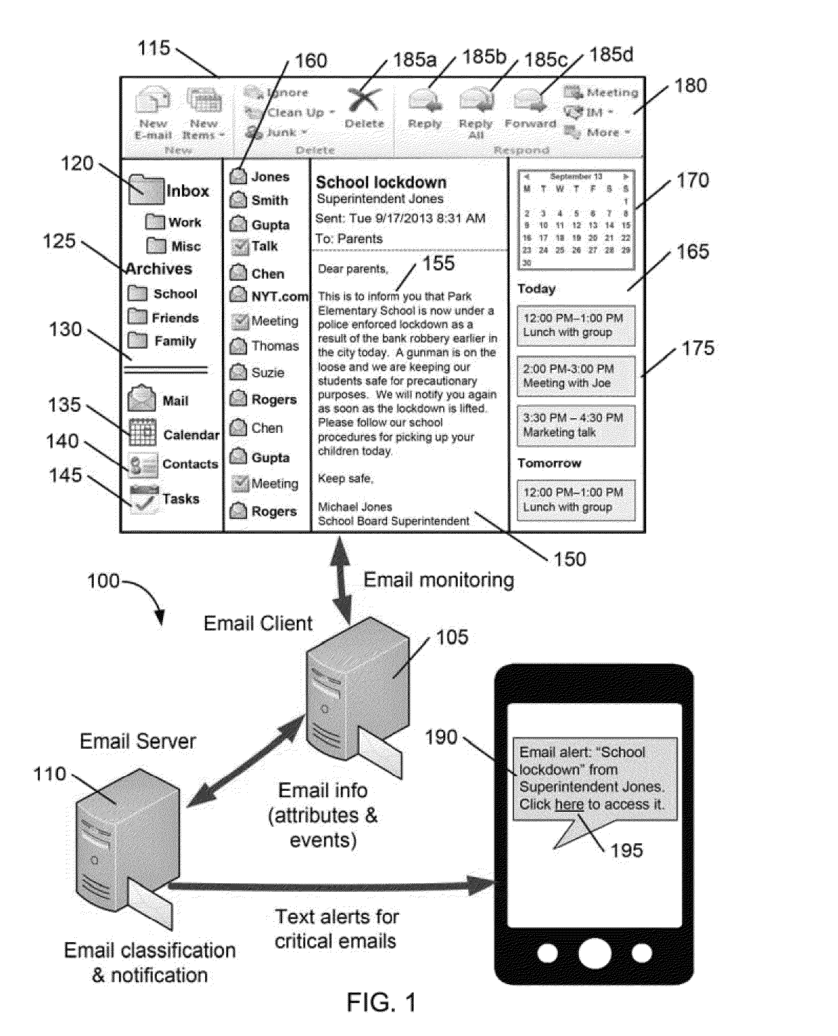

Referring now to FIG. 1, a schematic diagram of an environment where the email management system is used in accordance with various examples is described. Email management system 100 is implemented in a client/server architecture with an email client 105 and an email server 110. The email client 105 may be part of, a plug-in to, add-in for or extension of a user's email system 115 (e.g., Microsoft® Outlook, Pine, IBM Notes, etc.). The email system 115 has an inbox 120 for a user to receive emails from various parties and entities. The emails may be copied or moved to different folders (e.g., archives folders 125), enabling the user to manage his/her email intake/outtake. The email system 115 may be organized in different visual areas, such as a navigation pane 130 for the user to navigate through different folders and tools (e.g., calendar tool 135, contacts tool 140, and tasks tool 145), a reading pane 150 for the user to see a list of emails in the inbox 120 and the content of an email in the list (e.g., content 155 of email 160), a to-do pane 165 for the user to see a calendar 170 and items 175 marked on the calendar 170, and an actions pane 180 listing tasks that a user may perform on an email, such as, a delete task 185a, a reply task 185b. a reply-all task 185c, and a forward task 185d. Users may also choose to simply read the email and keep it in the inbox 120.

A user may typically receive anywhere from a few to hundreds or thousands of emails a day, making it difficult for the user to manage his/her inbox 120 and keep track of all emails. For example, a user may receive many irrelevant emails during the day interspersed with relevant and even critical emails. A critical email 160 is shown in reading pane 150 to indicate to the user that a school lockdown has been placed in effect due to a police emergency in town. This critical email 160 may arrive at the user's inbox 120 when the user is not at his/her desk, is preoccupied with another task, or receives many other emails around the same time frame. The critical email 160 may be easily ignored or forgotten by the user and the user may never even see its contents.

As described herein below, the email management system 100 is implemented to enable the user to be notified of a critical email. A critical email may be any message, appointment or meeting notification that is too important to miss or forget. For example, an email expressing urgency in a reply, an email coming from one's manager with an immediate request, or an email conveying an emergency in a community may all be critical emails. The email client 105 monitors the incoming emails in inbox 120 and transmits email information (e.g., extracted email attributes described below) to the email server 110. The email server 110 classifies the emails as critical using a set of predictive models of email importance and notifies the user of the critical emails by sending text message alerts to a user's mobile device. For example, a text message alert 190 may notify the user that a school lockdown is in place in accordance with critical email 160. The user may receive the text alert 190 in his/her smartphone and click on link 195 embedded thereon to access the critical email 160 and perform any email task (e.g., delete, reply, forward, etc.) as desired.

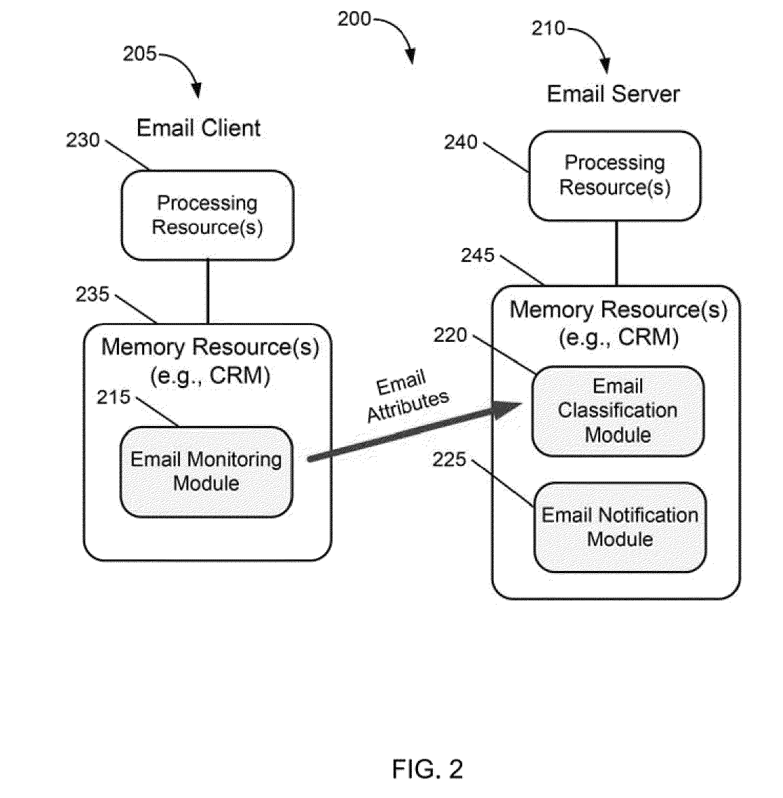

Attention is now directed to FIG. 2, which shows examples of physical and logical components for implementing the email management system. The email management system 200 is implemented in a client/server architecture with a client 205 and a server 210. The client 205 and the server 210 have various modules, including, but not limited to, an Email Monitoring Module 215 in client 205, an Email Classification Module 220 in server 210 and an Email Notification Module 225 in server 210. In an example implementation, modules 215-225 may be implemented as instructions executable by one or more processing resource(s) (e.g., processing resource 230 in client 205 and processing resource 240 in server 210) and stored on one or more memory resource(s) (e.g., memory resource 235 in client 205 and memory resource 245 in server 210). The email client 205 can be installed by the user as a plug-in to an email system (e.g., Microsoft® Outlook, Pine, IBM Notes, etc.). Once the email client 205 is installed, it requests the user's phone number. The user's phone number is sent to server 210 for the Email Notification Module 225 to send text message alerts of critical emails to the user.

A memory resource, as generally described herein, can include any number of memory components capable of storing instructions that can be executed by a processing resource(s), such as a non-transitory computer readable medium. It is appreciated that memory resource(s) 235 and 245 may be integrated in a single device or distributed across multiple devices. Further, memory resource(s) 235 and 245 may be fully or partially integrated in the same device (e.g., a server device) as their corresponding processing resource(s) (e.g., processing resource 230 for memory resource 235 and processing resource 240 for memory resource 245) or it may be separate from but accessible to their corresponding processing resource(s).

Email Monitoring Module 215 monitors the email usage of a user accessing the email management system 200. The Email Monitoring Module 215 extracts email attributes from the user's emails and sends the extracted attributes to the server 210 for classifying the emails into critical/non-critical. The Email Monitoring Module 215 also places event listeners on major email events such as preview, open email, delete, and so on, so that the user's interactions with his/her emails are logged and sent to the server 210 to aid in the email classification.

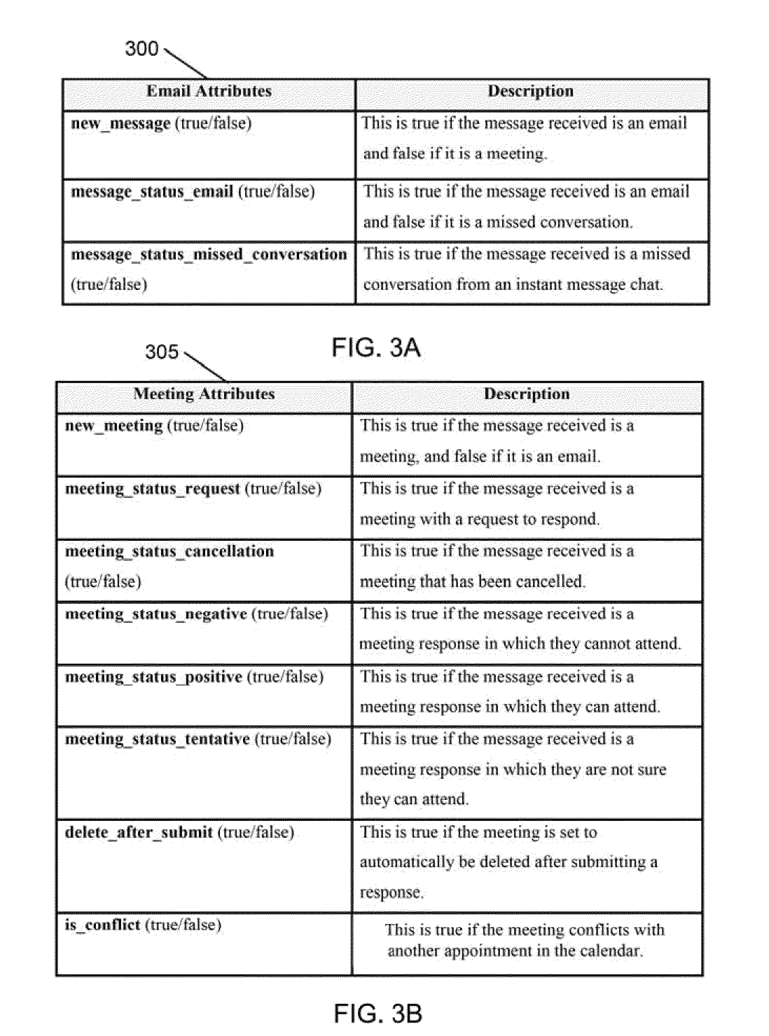

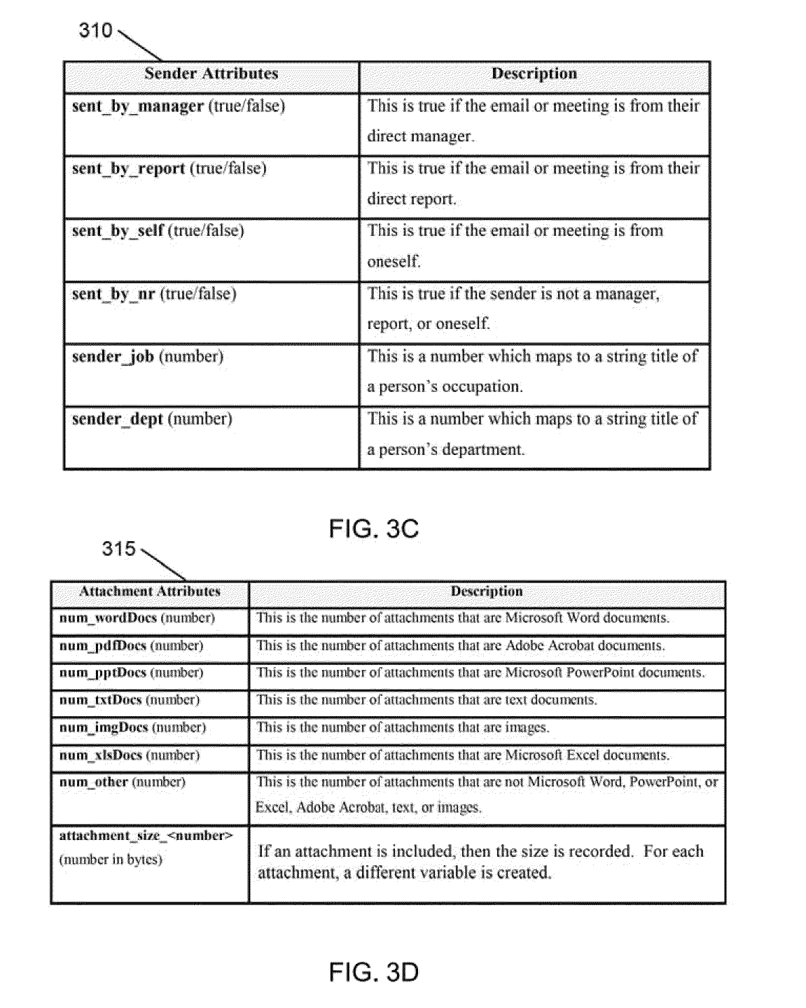

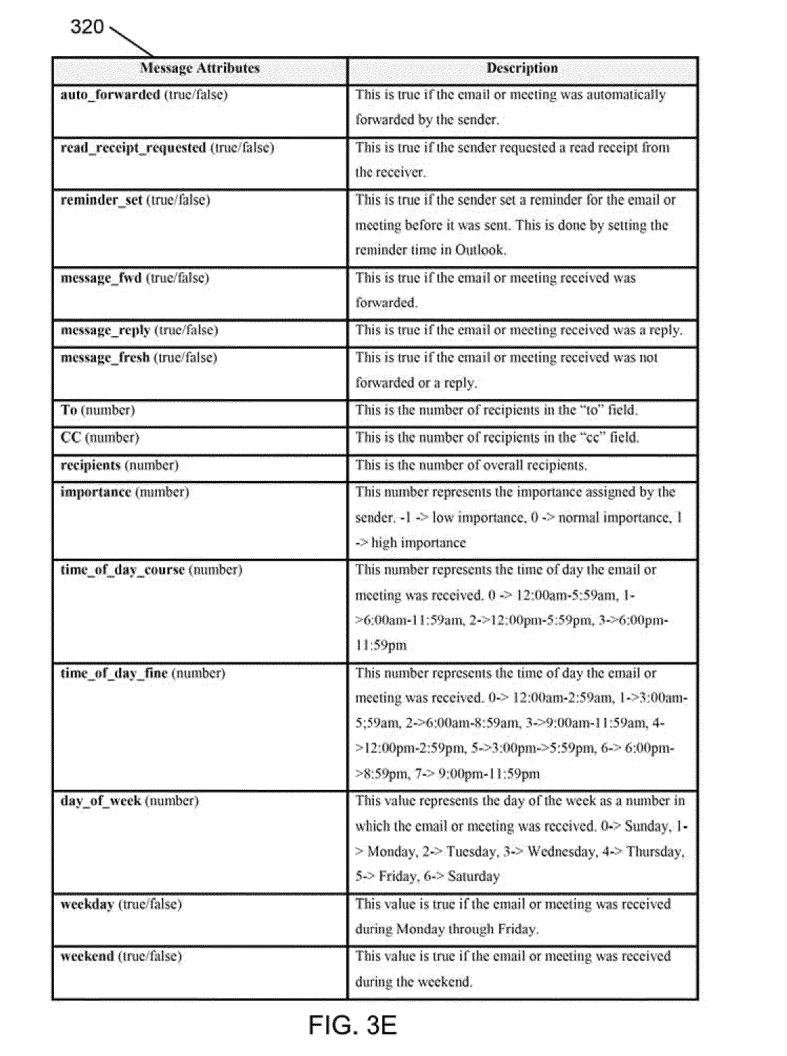

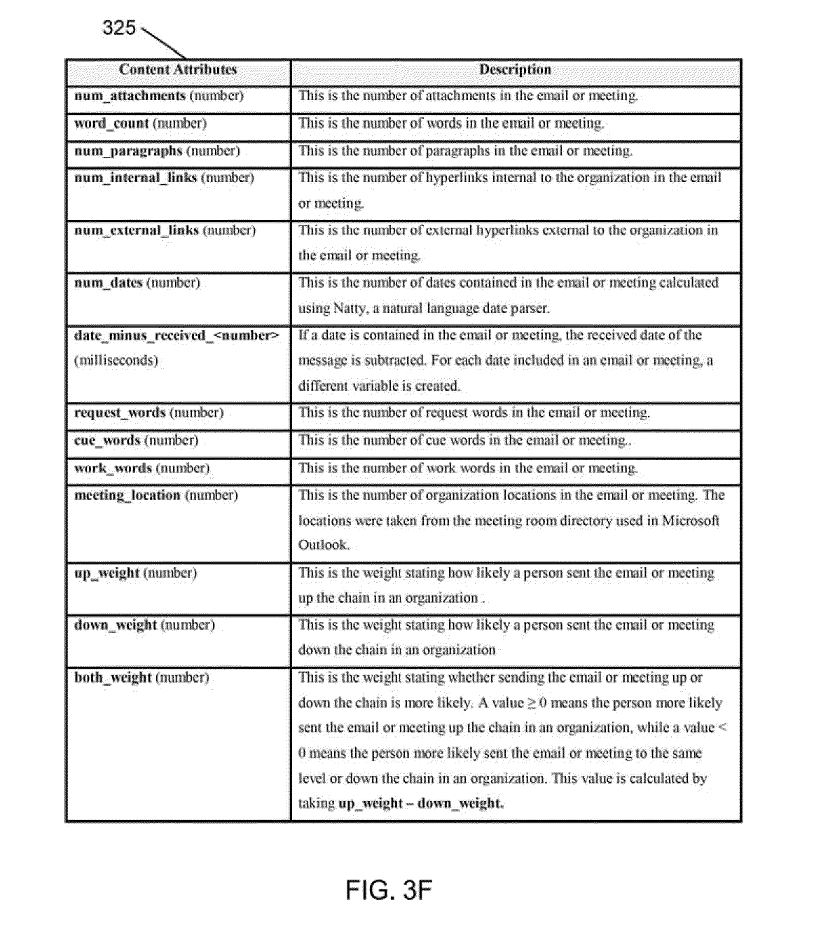

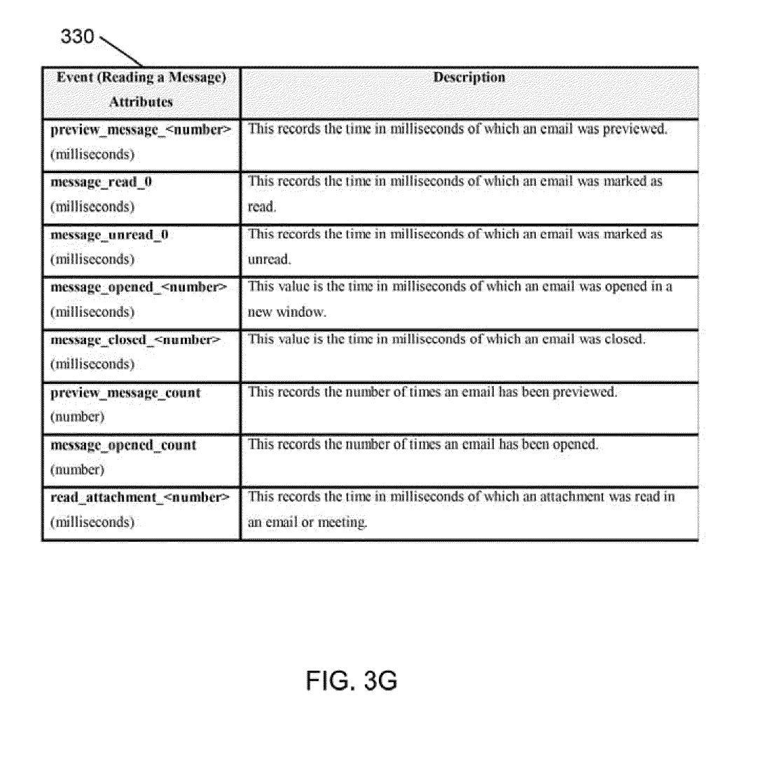

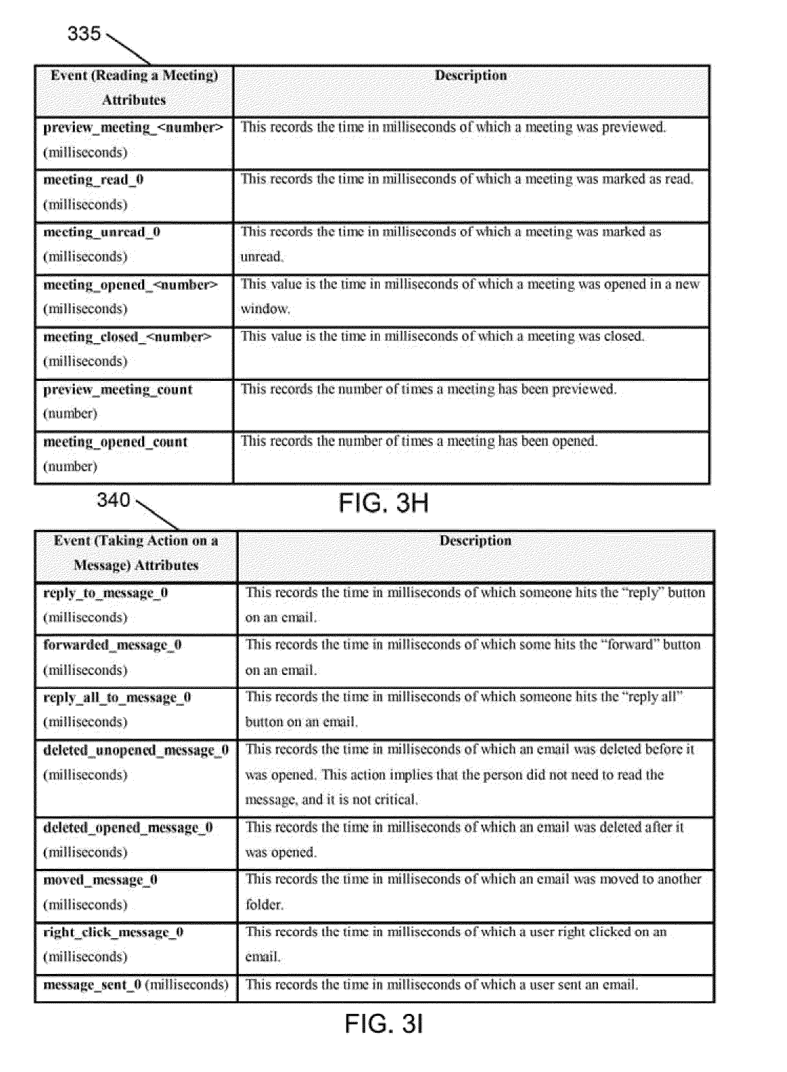

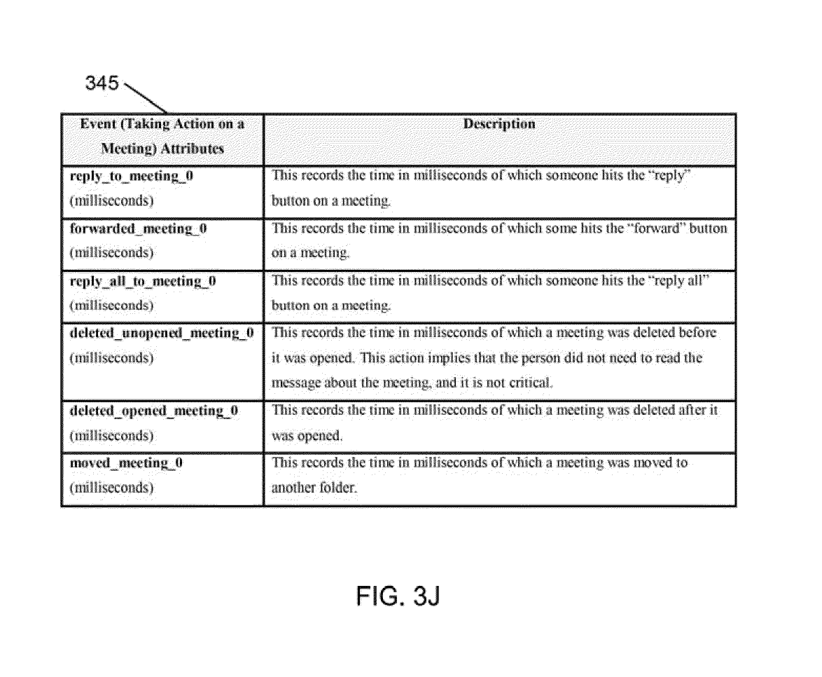

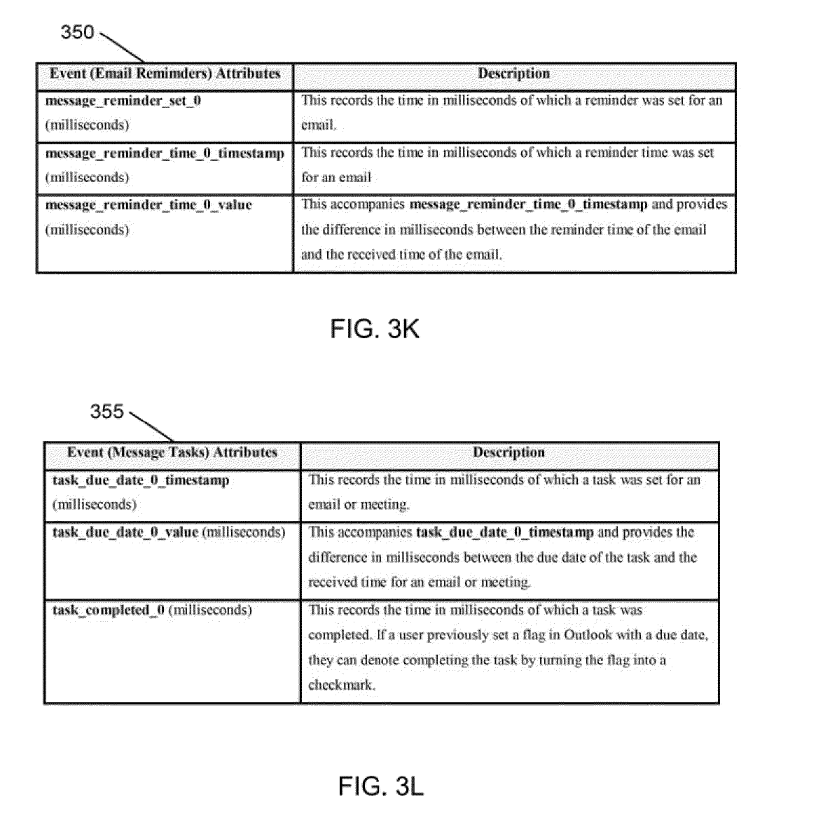

Example email attributes that can be extracted by the Email Monitoring Module 215 are shown in FIGS. 3A-L. In FIG. 3A, the email attributes 300 relate to the status of an email received by the user, e.g., whether the email received is a message or a missed conversation. In FIG. 3B, the email attributes 305 are used for emails that relate to meetings in the user's email system (e.g., Microsoft® Outlook, Pine, IBM Notes, etc.). In FIG. 3C, the email attributes 310 relate to the sender of the email (e.g., whether the email was sent by the user's manager, direct report, etc.) and in FIG. 3D, the email attributes 315 relate to attachments in the email, FIG. 3E shows email attributes 320 for capturing message information such as the number of recipients in the “To” and “CC” fields, whether the email was received during the week or the weekend, and so on. FIG. 3F shows email attributes 325 for capturing features of the email content such as the number of cue, request, and work words in the email, the number of paragraphs in the email, etc. In FIGS. 3G-L, the email attributes 330-355 capture events performed by the user when interacting with an email in his/her inbox. These events may include the user reading an email message (FIG. 3G), reading an email relating to a meeting (FIG. 3H), taking action on a message (FIG. 3I), taking action on a meeting (FIG. 3J), email reminders (FIG. 3K), and email tasks (FIG. 3L).

The attributes collected when new emails arrive at the user's inbox and through the event listeners are used in the predictive models run by the Email Classification Module 220 to determine whether the emails are critical or not. The predictive models are machine learning models generated using WEKA or another such tool. Example models that may be used include, but are not limited to, Sequential Minimal Optimization (“SMO”), Random Forest, (“RFST”), Decision Tree (“TREE”), and Support Vector Machine (“SVM”), among others. The predictive models are adaptive learning models that analyze the extracted email attributes and predict whether a given email is critical or not. Given a set of training examples, each marked as belonging to a set of critical or non-critical emails, the predictive models assign new examples into one category (critical) or the other (non-critical).

The training set for the predictive models can be generated in various ways, such as, for example, by using experienced sampling for adaptive learning over time. In experience sampling, users are asked questions to prompt them to note and record their experiences in real time. The questions/prompts are designed to trigger the user to classify on email as critical or non-critical as soon as the e-mail is received. Through experience sampling, information about the individual emails is recorded, while individual users label messages throughout the day along three dimensions: (1) identify critical emails; (2) calculate when a user must act on the email; and (3) determine what action would “address” the email, whether or not the action is detectable by the computer.

In various examples, the experience sampling training set can be generated by adding a training email plug-in to the email client 205 (e.g., a training plug-in added to the Email Monitoring Module 215) for a selected number of users. The training email plug-in interrupts a fraction of the emails received by the users (e.g., 30% of the received emails) in which users had an interaction to show them experience sampling prompts. For example, if a user chose to preview or reply to a given email, the odds that an experience sampling prompt would appear to the user would correspond to the fraction (e.g., 30%). Experience sampling prompts would appear immediately after a user closed, replied to, or forwarded an email. If the user previewed the email, the prompt would appear alter a certain time window (e.g., 10 seconds). In order to ensure data privacy, the actual body of the email, senders, or receivers could be emitted by the training plug-in so as not capture this sensitive data.

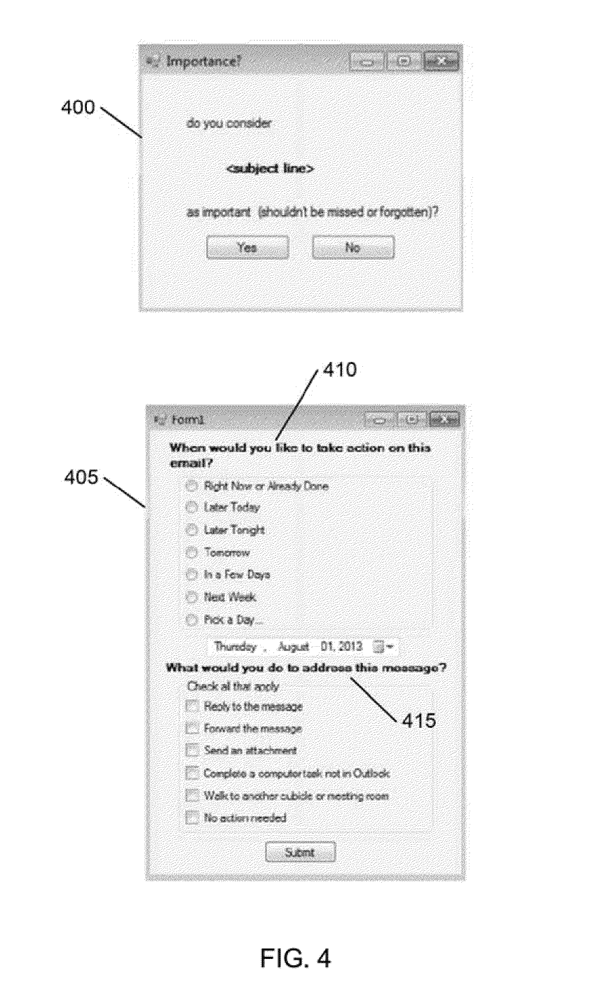

FIG. 4 illustrates example experience sampling prompts. Two sampling prompts 400-405 can be used to generate a training set. Prompt 400 provides users with a high level binary choice: is this email important (should not be missed or forgotten) or not? If an email was marked as important by the user, then a second prompt 405 would appear with two questions. The first question 410 allows users to specify the amount of time before the email would need an action taken. The second question 415 allows users to specify what action, or lack thereof, would be required to address the email. For emails marked as unimportant, no further prompt is presented. The data collected by the email training plug-in is sent to the email server 210 which uses the data for classifying the emails in question and for providing a training set to the Email Classification Module 220. In various examples, the training set can be collected multiple times so the predictive models adapt to changing email needs of the users. The predictive models can also adapt to include additional email attributes and events not captured by the example attributes shown in FIGS. 3A-L.

It should be noted that there is an inherent bias in using experience sampling to provide a training set. By only prompting users on emails that are being interacted upon, there is a high degree of likelihood that said email has a modicum of value, and may be critical. Subsequently, a large percentage of experience sampled messages may be labeled as critical, missing those messages which are not. This bias can be reduced by treating emails that are deleted without ever opening or previewing as not critical.

In addition to using the training set and collected email attributes to classify emails as critical or not, the Email Classification Module 220 also determines an email completion time and a completion condition that are used in setting email alerts for the user. The completion time specifies when an action (e.g., a reply, an acceptance to a meeting notification, etc.) on the email is due. The completion condition is a condition that needs to be satisfied for the email to be considered finished (i.e., no further action is needed). For example, a completion condition may include the user replying to the email, forwarding the email, attaching a document to the email, performing another task asked for in the email, and so on. It is noted that each email message may have any combination of completion conditions, for example, a given email may be considered finished only when it is replied to and it includes an attachment. Once an email is classified as critical, has not been completed and reaches its due date, the Email Notification Module 225 sends text message alerts to the user. The email is considered finished when the email completion time and the completion condition are satisfied.

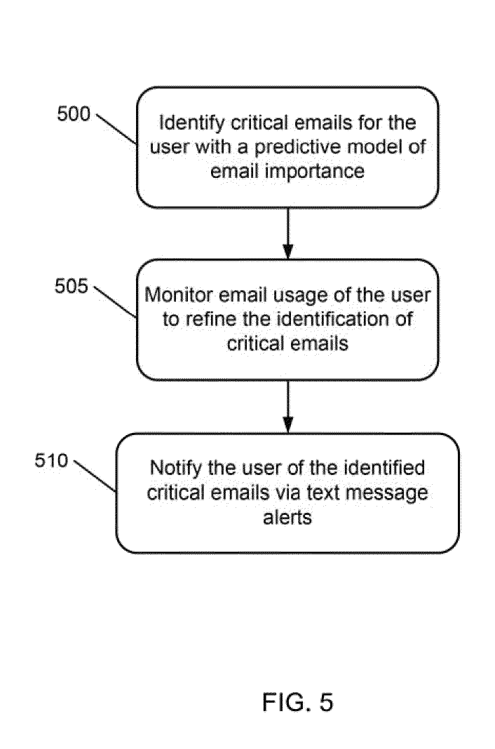

The operation of Email Monitoring Module 215, Email Classification Module 220, and Email Notification Module 225 are now described in detail. Referring to FIG. 5, a flowchart of example operations of the email management system of FIG. 2 for notifying users of critical emails via text message alerts is described. First, critical emails for the user are identified with predictive models of email importance (500). Two sets of predictive models are used in the classification of emails: (1) a first set of models to classify new, incoming emails to the user's mailbox that have not yet been interacted with by the user; and (2) a second set of models to classify emails that have been interacted with by the user. The second set takes into account the actions the user performed when interacting with the emails and is therefore a better predictor of email criticality than the first set. For example, knowing that the user replied to an email from his/her manager right away upon receiving it may indicate to the user that subsequent emails from that manager may be critical emails. The email usage of the user is therefore monitored to refine the identification of critical emails (505). The user is then notified of the identified critical emails via text message alerts (510).

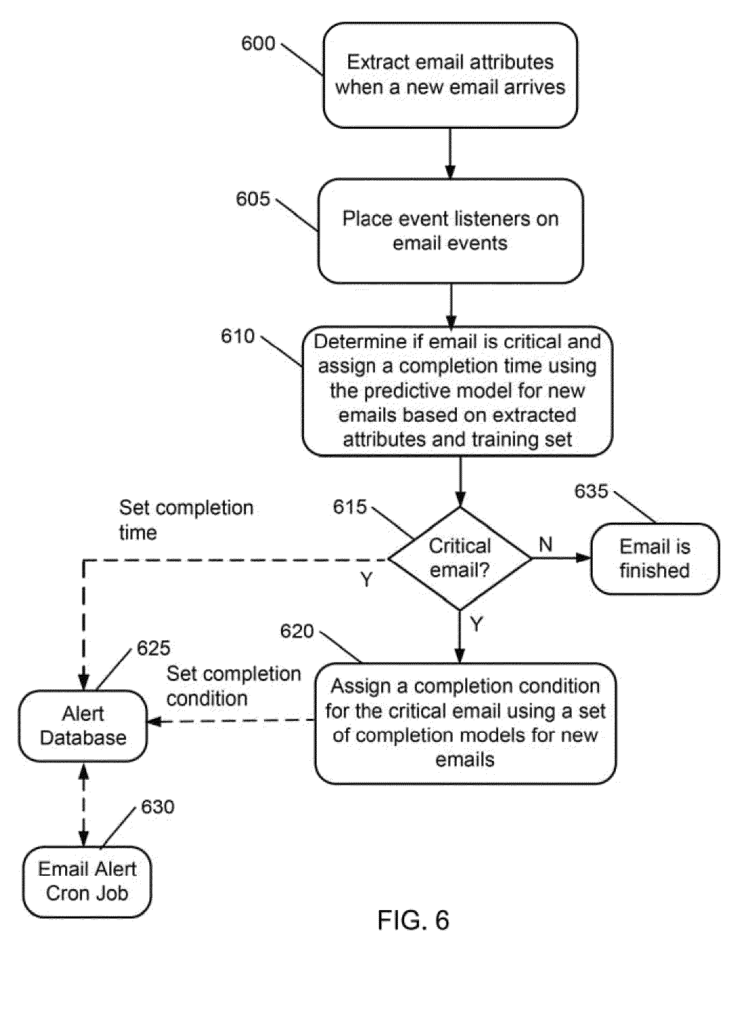

Attention is now directed to FIG. 6, which shows a flowchart for classifying new, incoming emails. First, when a new email arrives in the user's mailbox, email attributes (e.g., attributes 300-355 in FIGS. 3A-L) are extracted by the email client 205 and sent to the server 210 (600). Next, event listeners are placed on email events that may be performed by the user, such as, for example, preview, open email, or delete (605). The Email Classification Module 220 then classifies the new emails as critical using a predictive model for new emails based on the extracted email attributes (610).

If an email is critical (615), a completion time is assigned for the email and a set of email completion models for new emails are run to determine a completion condition for the email (620). The set of completion models for new emails is associated with a set of email completion tasks, including, but not limited to, a reply task, a forward task, an attachment task, a computer task, an offline task and a no-action task. For example, six completion models may be used, one for each one of the six tasks. It is noted that by treating each completion task as a separate task in the email classification and using different models for each task, higher performance can be achieved when determining a completion condition for each email. It is also noted that each email message may have any combination of completion tasks, for example, a given email may be considered finished only when it is replied to and it includes an attachment.

The completion time and completion condition are stored in an alert database (625) that lists all alerts to be sent for the critical emails. An Email Alert Cron Job is then periodically executed on the email client 205 (e.g., every 10 minutes, every hour, etc.) to go through the alerts in the alert database (630). The Email Notification Module 225 uses the completion time determined by the Email Classification Module 220 to determine when to send out text message alerts for the critical emails.

Note that the operations shown in FIG. 6 are executed to determine the criticality of a new email. The new email stops being new (i.e., untouched by the user) when the user interacts with it. Any user interaction event with the new email is captured by the event listeners. Once an email has been interacted with, the interacted email is analyzed again to determine whether it is still critical or not. As described above, a second set of predictive models is used for this purpose. This second set of models takes into account users' interaction events with the emails and is a better predictor of email criticality.

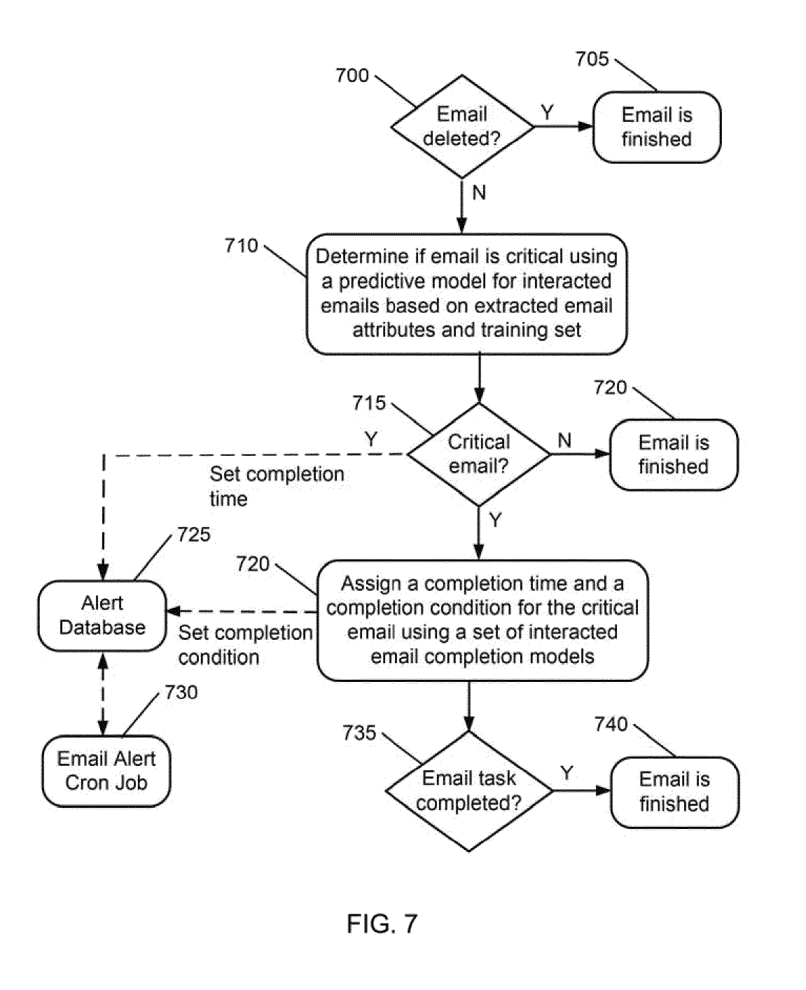

Referring now to FIG. 7, a flowchart for refining the classification of emails that have been interacted with by the user is described. First, it is determined whether the user's interaction with the email consisted in the user deleting the email (700). If the email has been deleted, then the email is finished (705) and no further action needs to be taken. A deleted email cannot be considered critical because if it were, the user would not have deleted it. For those emails that were not deleted by the user but were interacted with in another way (e.g., by replying to the email, forwarding the email, etc.), the Email Classification Module 220 refines the classification of the interacted emails using a predictive model for interacted emails based on the extracted email attributes (710).

If an email critical (715), a completion time is assigned for the email and a then a set of email completion models for interacted emails are run to determine a completion condition for the email (720). The completion time and completion condition are stored in an alert database (725) that lists all alerts to be sent for the critical emails. An Email Alert Cron Job is then periodically executed on the email server 210 (e.g., every 10 minutes, every hour, etc.) to go through the alerts in the alert database (730). The Email Notification Module 225 uses the completion time determined by the Email Classification Module 220 to determine when to send out text message alerts for the critical emails. If the email task is completed (735), the email is considered finished (740).

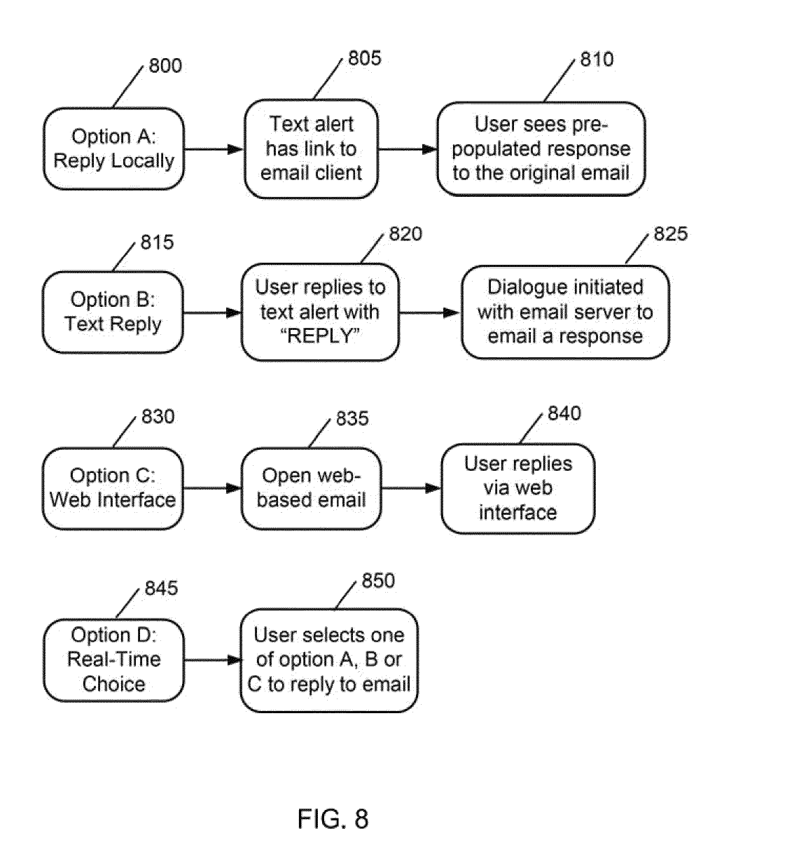

When an email is due, the email server 210 sends users a text message alert including the sender's email address, the subject line, and a unique randomly generated link to the email server 210. FIG. 8 illustrates different options that may be used when sending out the text message alerts to the user. In option 800, the link in the text alert is a link to the email client 205 (805). The user clicks on the link to open the email client and a prepopulated response to the critical email subject to the alert (810). The user can fill the prepopulated response to respond to the critical email as desired. In option 815, the user chooses to reply to the text alert with the word “REPLY” (820). The user's response triggers a dialogue with the email server 210 to email a response to the email's sender (825). In option 830, the text alert contains a link to a web-based email client (835). The user clicks on the link to reply to the critical email via a web interface (840). In option 845, the user can select one of the options 800, 815, or 830 to respond to the text alert. That is, the user can respond by clicking on a link to the email client, by replying to the text alert, or by clicking on a link to a web-based email client (850). After the user responds to the critical email and the email is deemed to be no longer critical, any information stored in the email server 210 is removed for the security and privacy of the users.

It is noted that options 800, 815, 830 and 845 are examples of text message alerts that may be used. Other types of alerts may be sent as well, such as alerts providing a list of critical emails to the user. This list can also be provided in the user's email system for easy viewing in the user's desktop, laptop, or mobile device. It is also noted that the text alerts are sent when the emails are due. In other examples, the text alerts can be sent when the email is first sent to the user. The text alerts may also be adaptive to a user's personal needs. In one example scenario, when a user receives an alert, the user would have options such as replying with an email body to see the body of a message. If the user wants to interact with an email further, this would confirm that it is a critical message. Furthermore, options via text message such as “not critical” could provide more samples of not critical emails for individual users.

Another example would involve integrating the context of a user before sending an alert. Machine learning techniques may be used to help determine the best time to alert users when they receive a critical message. For example, calendar information may be used to send alerts to users only when their calendar indicates that they are available. In the event that a text message is sent at the wrong time, a snooze feature could be integrated for the user. Additionally, if the email management system detects that an email is relevant to a meeting, then a text alert could be sent in advance so the attendee is better prepared for the meeting.

The email management system described herein leverages the use of SMS because it has a significantly quicker response time than email, has a higher threshold for annoyance and a lower usability demand. In addition, about 50% of mobile device users do not have push notifications on their phones. SMS also has a higher degree of accessibility than email; if users travel to a low data-coverage area, rural part of the world, or a conference or event where the data network is over-stressed, email access may not be strong or readily available. However, SMS remains an open conduit for communication, allowing users to still receive messages that can inform their actions (e.g. get to a computer or internet access). Therefore, by judiciously using SMS to alert users of critical emails, the email management system mitigates the byproduct of email overload and emails falling through the proverbial crack.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A computer implemented method for notifying a user of critical emails via text messages, comprising;
identifying, by a computer, critical emails for the user with a set of predictive models of email importance;
monitoring, by a computer, email usage of the user to refine the identification of critical emails; and
notifying, by a computer, the user of the identified critical emails via text message alerts.

2. The computer implemented method of claim 1, wherein the set of predictive models of email importance comprises a set of machine learning models for identifying a critical email based on a set of extracted email attributes and an experience sampling training set.

3. The computer implemented method of claim 2, wherein the set of predictive models determines a completion time for each critical email.

4. The computer implemented method of claim 3, further comprising assigning a completion condition for each critical email by running a set of email completion models for a set of email completion tasks.

5. The computer implemented method of claim 1, wherein monitoring email usage of a user comprises detecting user interactions with emails with event listeners.

6. The computer implemented method of claim 4, wherein notifying the user of the identified critical emails by sending text message alerts to the user comprises sending a text message alert to the user for each critical email based on its completion time and completion condition.

7. The computer implemented method of claim 6, wherein the text message alert comprises an option selected from the group consisting of an email server link, a web email link, a reply option and a real-time option.

8. The computer implemented method of claim 2, wherein the experience sampling training set is derived from users' responses to a set of experience sampling prompts.

9. A system for notifying a user of critical emails, comprising:
a processor; and
a set of memory resources storing a set of modules with routines executable by the processor, the set of modules comprising:
an email classification module to classify a user's emails as critical and non-critical using a set of predictive models and based on monitored email usage of the user; and
a notification module to notify the user of the critical emails via text message alerts.

10. The system of claim 9, wherein the email classification module comprises routines to extract email attributes that are used to classify the user's emails.

11. The system of claim 10, wherein the extracted email attributes comprise email attributes selected from the group consisting of attributes relating to a status of an email received by the user, attributes that relate to meetings for the user, attributes relating to a sender of a user's email, attributes relating to attachments in a user's email, attributes capturing message information, attributes relating to email content, attributes capturing a reading event, attributes capturing a meeting event, attributes capturing an email action event, attributes capturing a meeting action event, attributes capturing email reminders and attributes capturing email tasks.

12. The system of claim 9, wherein the notification module comprises a set of routines to determine which identified critical emails are due to be alerted to the user, wherein the identified emails that are due to be alerted to the user are stored in an alert database.

13. A non-transitory computer readable medium comprising instructions executable by a processor to:
extract email attributes when a new email arrives in a user's inbox;
determine whether the new email is a critical email based on the extracted attributes and a training set; and
if the new email is a critical email:
assign a completion time and a completion condition for the critical email;
monitor interactions of the user with the critical email;
refine the determination that the email is critical based on the monitored interactions; and
send a text message alert to the user according to the completion time and the completion condition.

14. The non-transitory computer readable medium of claim 13, further comprising instructions to determine whether the completion condition has been fulfilled.

15. The non-transitory computer readable medium of claim 14, further comprising running an email alert cron job periodically to determine when to send out text message alerts to the user.
